(19) United States
(12) Patent Application Publication
(10) Pub. No.: US 2014/0117774 A1
(43) Pub. Date: May 1, 2014

(54) POWER FEED ENTRY CIRCUIT FOR TELECOMMUNICATION APPLICATIONS

(71) Applicant: CIENA CORPORATION, Hanover, MD (US)

(72) Inventors: Terrence M. McGill, SR., Stevensville, MD (US); Richard M. Hobbs, Walkersville, MD (US); Michael J. Wingrove, Kanata (CA)

(73) Assignee: CIENA CORPORATION, Hanover, MD (US)

(21) Appl. No.: 13/666,592

(22) Filed: Nov. 1, 2012

(51) Int. Cl. H02B 1/24

(52) U.S. Cl. 307/112

(57) ABSTRACT

A power feed entry circuit, a module with the power feed entry circuit, and a daughter board with the power feed entry circuit include a first circuit coupled to inputs and outputs, wherein the first circuit is configured for power connections, return isolation relays, diode Or-ing, and output status-indication light-emitting diodes (LEDs); a second circuit coupled to the first circuit, the inputs, and the outputs, wherein the second circuit is configured with a hot swappable controller and provides common-mode and differential mode power line filtering; a third circuit coupled to the first circuit, wherein the third circuit is configured for alarm monitoring of the first circuit and the second circuit; and a fourth circuit coupled to the first circuit and the third circuit, wherein the fourth circuit comprises a dual feed high and low active field effect transistor Or-ing circuit.

### FIELD OF THE INVENTION

Generally, the field of art of the present disclosure pertains to a power feed entry circuit for telecommunication applications, and especially high power telecommunication applications, and more particularly, to a power feed entry circuit that includes hybrid active Or-ing and return current balance features.

### BACKGROUND OF THE INVENTION

Some telecommunication (telecom) carriers now target a twenty percent power reduction per year for the equipment that they deploy. This is in response to increasing power consumption in central offices (COs), which is due to higher bandwidth capacities, increasing line card port densities, more intelligent processing requirements, more complex chip implementations, and the like. Higher power consumption equates to higher operating costs for telecom providers, and leads to more complex engineering challenges for equipment suppliers in dealing with thermal management, for example. Providers sometimes require equipment suppliers to conduct energy efficiency testing on the products that they purchase. For example, some providers require equipment suppliers to generate a Telecommunication Equipment Energy Efficiency Rating (TEEER). Other providers are waiting for the Alliance for Telecommunication Industry Solutions (ATIS) to complete an energy efficiency standard for products before they adopt a similar energy efficiency requirement standard. The more power a system draws with the data rate processed remaining the same, the lower the product is rated and the less competitive the product is.

High power telecommunication systems are typically made up of numerous subsystem modules that are required to meet various facility power interface requirements, including power feed and return isolation for the carrier-provided redundant power feeds and returns. The technique used to provide this isolation involves the enforcement of directional current flows on each of the individual feed and return paths, such that current from one feed source cannot flow in a reverse direction towards another feed source, with corresponding measures taken for the respective return paths. This technique is commonly referred to as Or-ing, and is based on the common reference for a diode topology that fulfills this requirement. Presently, there are two primary circuit designs available to product manufacturers that provide these feed and return Or-ing isolation functions for modules used in telecom applications, namely conventional passive diode Or-ing circuits and active Or-ing circuits.

Conventional passive diode Or-ing circuits include a diode placed in series with each source feed and return leg. These circuits are considered by most telecom power circuit designers to be very reliable, although they have significant associated power losses. Active Or-ing uses one or more power MOSFETs (metal-oxide-semiconductor field-effect transistors) with active Or-ing controllers in place of each series path diode. The present state-of-the-art active Or-ing approach is much more efficient, but has numerous limitations that present problems which must be overcome when considering high power, high availability telecomm applications. These challenges with the conventional active Or-ing include limited load capability, lack of adequate transient and fault immunity, high probability of traffic impact if an Or-ing subcircuit component failure occurs, and alarm indication issues. With respect to limited load capabilities, typical active Or-ing circuits are limited to less than 300 W. With respect to alarm indication issues, present state of the art active Or-ing circuits do not include a capability to detect negative feed fuse openings at controller inputs.

Conventional power entry circuits used for high power telecom modules use high power Schottky diodes in an Or-ing circuit configuration for the feed and corresponding return line isolation function, as this type of diode offers the lowest forward voltage drop and thus lowest losses for the conventional approach. Modern switching interface line modules switch up to 500 GB/s, resulting in per-module power loads often in excess of 500 W. The use of the latest technology (i.e. lowest voltage drop) diodes in such applications may result in a contribution to module power losses of over 12 watts (due to diode losses only) for a 500 W module and significant increases in the temperatures of both the printed circuit board (PCB) and environmental ambient. These temperature increases result in additional power losses for collocated high power components, such as field programmable gate arrays (FPGAs), application specific integrated circuits (ASICs), and power conversion devices that may draw significantly more current at higher ambient temperatures. Operation of all of these components at elevated temperatures also reduces the device mean time between failures (MTBF) of the components, affecting system reliability and long term operational and replacement costs. In addition, the higher aggregate system module temperatures require an increase in system fan speed. Operation of fans at higher speeds further increases system power losses, as well as reduces the life of the fans, with additional impact to both system costs and MTBF. Thus, even with best-available Schottky diodes, the incurred dissipation becomes a competitive limitation for current generation high power telecom modules.

Another major limitation of the Or-ing diodes currently used for feed isolation is that if a failure occurs, such as a short circuit failure in one or more of the four diodes, there is no failure indication, as this condition is very difficult to detect and the loss of power bus feed isolation may be present, but undetected, with the potential for both EMC and safety compliance failures (including potential human safety hazards for service or operational personnel). If the diode failure occurs with any diode in an open circuit mode, then power is absent from the corresponding feed, possibly without indication to the system and, upon opposite feed removal, may be traffic-affecting. The present state-of-the-art active Or-ing circuits using MOSFETs have output load current capability that is limited to approximately 5 A, corresponding to significantly less than 300 W deliverable power per module. This 300 W limit is far less than that required for many applications. The present state-of-the-art active Or-ing circuits also do not contain adequate protection to prevent failure of controllers when exposed to line or load faults or transient feed voltages. The present state-of-the-art active Or-ing circuits further do not include features for negative feed fuse detection for the opening of fuses located at the MOSFET inputs. Many carriers require that all fuse failures be detected and reported though system alarms. The direct measurement of a failure of either negative feed fuse at the controller input is not detectable using any available negative controllers due to problems introduced by feedback within the negative controller devices. The present state of the art active OR-ing circuits do not include fail-safe power path circuitry such that power is not interrupted to the critical module circuitry in the event of a MOSFET open-circuit failure or MOSFET drive circuit failure. Additionally, state of the art circuits do not include means of return current power path control such that return current flows only back to the active source in the event that one of the two redundant input sources fails or is switched off at the CO.

### BRIEF SUMMARY OF THE INVENTION

In an exemplary embodiment, a power feed entry circuit includes inputs coupled to redundant power feeds; outputs coupled to components on a module; a first circuit coupled to the inputs and the outputs, wherein the first circuit is configured for power connections, return isolation relays, diode Or-ing, and output fuse light emitting diodes (LEDs); a second circuit coupled to the first circuit, the inputs, and the outputs, wherein the second circuit is configured with a hot swappable controller and for common-mode and differential mode power line filtering; a third circuit coupled to the first circuit, wherein the third circuit is configured for alarm monitoring of the first circuit and the second circuit; and a fourth circuit coupled to the first circuit and the third circuit, wherein the fourth circuit comprises a dual feed high and low active field effect transistor Or-ing circuit; wherein the first circuit, the second circuit, and the fourth comprise high voltage and high current circuits, and wherein the third circuit comprises a high and low voltage and low current circuit. The power feed entry circuit is configured for loads in excess of 500 W with a corresponding power dissipation by the first circuit, the second circuit, and the third circuit of less than 2 W. The fourth circuit can include a plurality of Or-ing metal-oxide-semiconductor field-effect transistors (MOSFETs), and wherein the third circuit is configured to monitor voltage drops across the MOSFETs source-to-drain nets for comparison to programmed controller alarm voltage thresholds and for raising alarms based thereon. The third circuit can be configured to monitor a plurality of components in the first circuit, the second circuit, and the fourth circuit for operational status and for raising alarms based thereon. The fourth circuit can include a fail-safe alternate power path using power diodes connected in parallel across each MOSFET. The power diodes can be arranged in a hybrid parallel diode architecture that provides the capability of supplying power under power path component fault conditions. The first circuit can include an active power feed return current balance to isolate the return current when a feed is removed.

In another exemplary embodiment, a module for use in high powered telecom applications includes a board including a plurality of connectors to a backplane; and the power feed entry circuit coupled to some of the plurality of connectors for receiving power feeds and coupled to at least one component on the board for providing isolated power thereto. In yet another exemplary embodiment, a daughter board for use in a high powered telecom module includes a printed circuit board including the power feed entry circuit, wherein the printed circuit board is mounted on the high powered telecom module. This provides an added feature of modular replaceability in the event of a failure as well as board layout-efficiency benefits due to the daughter board providing extra component surface area over the main board.

### BRIEF DESCRIPTION OF THE DRAWING(S)

Exemplary and non-limiting embodiments of the present disclosure are illustrated and described herein with reference to various drawings, in which like reference numbers denote like method steps and/or system components, respectively, and in which:

FIG. 1 is a functional block diagram of a power feed entry circuit;

FIG. 2 is a circuit schematic of power connectors, return isolation relays, diode Or-ing, and output fuse LEDs;

FIG. 3 is a circuit schematic for a dual feed high and low active FET Or-ing circuit;

FIGS. 4-5 are circuit schematics of six status monitor circuits using optoisolators and LED for monitoring of active Or-ing FET, controllers, and fuses (both visible and electrical outputs are provided);

FIG. 6 is a circuit schematic of a relay status monitor circuit;

FIG. 7 is a circuit schematic of a relay fuse status monitor circuit;

FIG. 8 is a circuit schematic of the host module interface circuit connections.

FIG. 9 is a circuit schematic of a hot swap controller, including low voltage battery disconnect (LVD), overvoltage cutoff, and recovery functionality, as well as common-mode/differential mode (CM/DM) power line filtering;

FIG. 10 is a perspective view of an exemplary implementation of the power feed entry circuit; and

FIG. 11 is a perspective view of the power feed entry circuit installed on a host module.

### DETAILED DESCRIPTION OF THE INVENTION

In various exemplary embodiments, a power feed entry circuit, an active Or-ing module, and a daughterboard (collectively referred to herein as a power feed entry circuit) are described with hybrid active Or-ing, return current balance and fail-safe power path preservation features. The power feed entry circuit provides a unique, high-power active Or-ing implementation designed to meet the environmental, regulatory, reliability, and high-availability demands of a state-of-the-art telecom, datacom, etc. power-entry application. This power feed entry circuit provides high-power MOSFET-based active Or-ing for minimal power losses while maintaining fault tolerance through an innovative hybrid diode structure with a unique circuit implementation for both self-fault monitoring and maintenance of the critical power path in the event of a fault. In addition, the power feed entry circuit provides a level of monitoring functionality that would normally not be available in present state-of-the-art designs. The power feed entry circuit includes extensive protective features for robustness and reliability for sustained operation in the harsh telecom environment as well as active power feed return isolation for prevention of reverse current flow on non-energized input feeds. This design provides a uniquely-adapted implementation that addresses the compound demands of a telecomm carrier-grade power-entry solution. The power feed entry circuit is designed to provide failure indications and take up as little space as possible. The power feed entry circuit is designed to meet all customer compliance requirements including, without limitation, NEBS GR63, GR1089, GR-78 Issue 2, ATT-TP-76450 and ATT-TP-76200

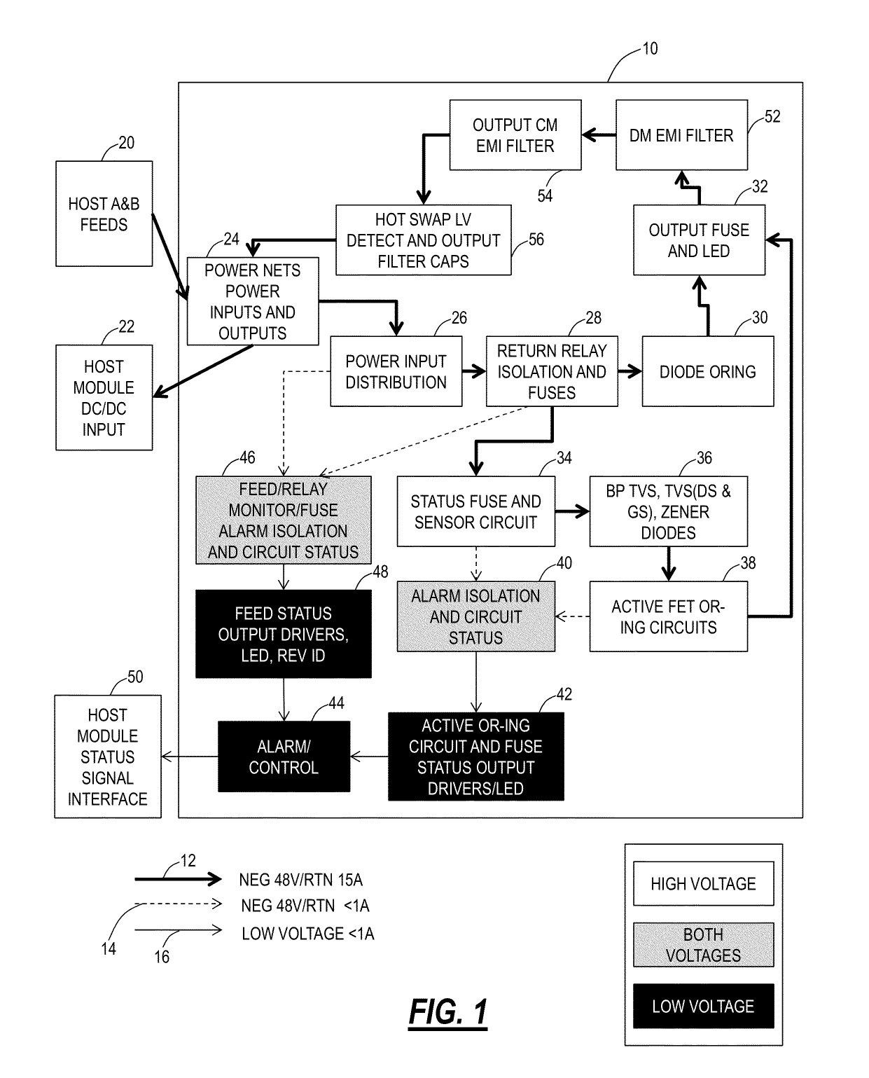

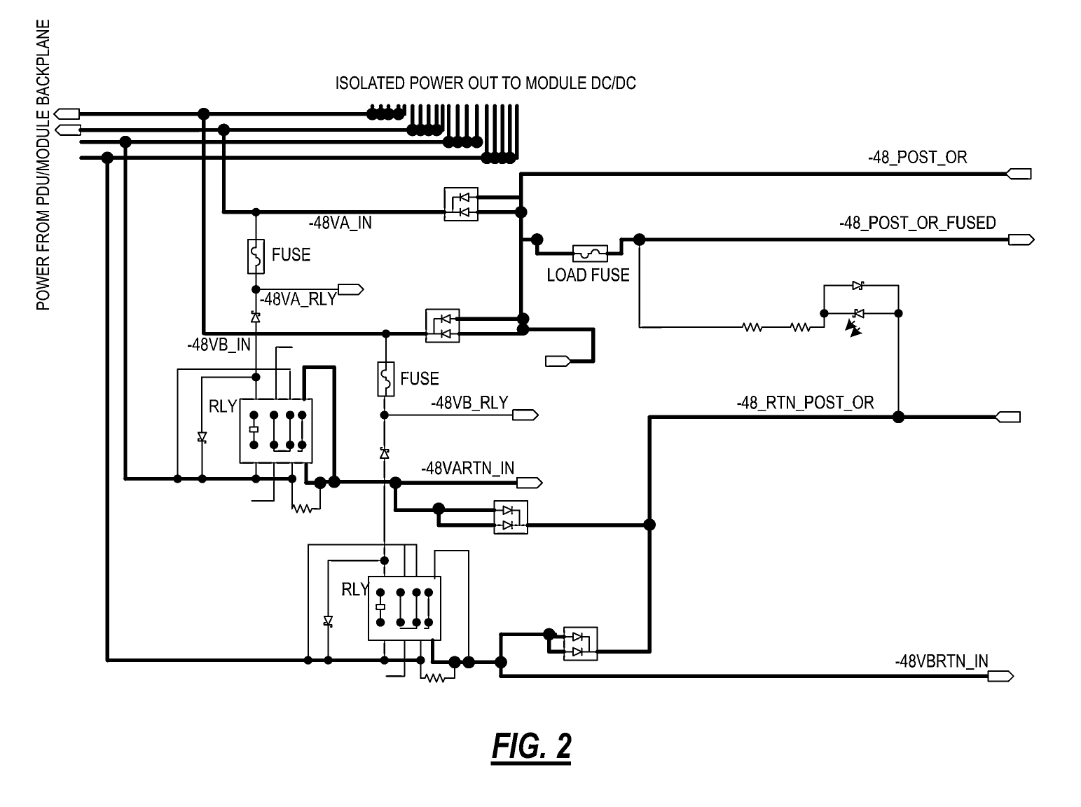

Referring to FIGS. 1-9, in an exemplary embodiment, a functional block diagram illustrates a power feed entry circuit 10 in FIG. 1 with associated circuit diagrams illustrated in FIGS. 2-9. Specifically, the power feed entry circuit 10 can be a module or daughterboard that is used on another type of module to reduce the power loss associated with providing power feed isolation while maintaining reliability and providing alarm functions required for the intended applications including connections to Telecommunications Central Office power. Exemplary module types can include, without limitation, optical transceivers, switch modules (e.g., packet, time division multiplexed, combinations thereof, etc.), data line blades, control modules, etc. The power feed entry circuit 10 includes various functional components implemented in circuitry with each of the following functional components include inputs and/or outputs as −48 VDC/RTN (return) of about 15 A (denoted by lines 12), −48 VDC/RTN (return) of less than 1 A (denoted by lines 14), or low voltage of less than 1 A (denoted by lines 16). Further, each of the functional components can be classified as high voltage (denoted by white boxes), low voltage (denoted by black boxes), or both high and low voltages (denoted by gray boxes).

The power feed entry circuit 10 is wired to A & B feeds 20 for inputs and provides module DC/DC input 22 as outputs. Specifically, the feeds 20 can be redundant, A and B power feeds from a power device collocated with the power feed entry circuit 10. The power device can provide two separate −48 VDC feeds to the power feed entry circuit 10 and can be referred to as a power distribution unit (PDU), a bank of batteries, generator, rectifier unit, etc. The module DC/DC input 22 provides return isolated power to its associated module or device. The power feed entry circuit 10 assembly is designed to reduce the power loss associated with providing the power feed isolation, filtering and hot swap control functions for telecom module assemblies that are at the load of the PDUs that supply modules with Negative 48 VDC Central Office power. The power feed entry circuit 10 is installed on the modules near the module backplane power connectors to serve as the interface circuit between the feed protection fuses and the module isolated DC/DC converter inputs as illustrated by the module block diagram in FIG. 1. The power feed entry circuit 10 was also designed to provide failure indications, easy removal and take up as little space as possible. The power feed entry circuit 10 is field replaceable and uses parts meeting all requirements of the application specifications for safety and EMC including ATT-TP-76450, ATT-TP-76200 and GR-78 Issue 2.

The feeds 20 and the inputs 22 interface to a power nets and power inputs and outputs circuit 24 which connects to a power input distribution circuit 26 which connections to a return relay isolation and fuse circuit 28 which connects to a diode Or-ing circuit 30 which connects to an output fuse and light emitting diode (LED) circuit 32. Each of the circuits 24, 26, 28, 30, 32 is a high voltage circuit with high current therebetween. FIG. 2 illustrates an exemplary circuit implementation of the circuits 24, 26, 28, 30, 32, namely FIG. 2 is a circuit schematic of power connectors, return isolation relays, diode Or-ing, and output fuse LEDs. FIG. 2 includes both high current (e.g., 15 A) paths illustrated in bold lines and low current paths (e.g., <1 A) illustrated normally. FIG. 2 shows the power feed entry circuit 10 has inputs from the PDU such as via backplane (BP) connectors into a module hosting the power feed entry circuit 10, and outputs providing isolated power to the module. Using the features shown in FIG. 2, the circuit 10 provides A and B return bus balanced current flow with associated feeds for dual power source applications as required for ATT-TP-76200 compliance. FIG. 2 shows connections between the high power input circuit of modules and the disclosed circuits including the return isolation connections, parallel hybrid protection diodes as well as input to active Or-ing.

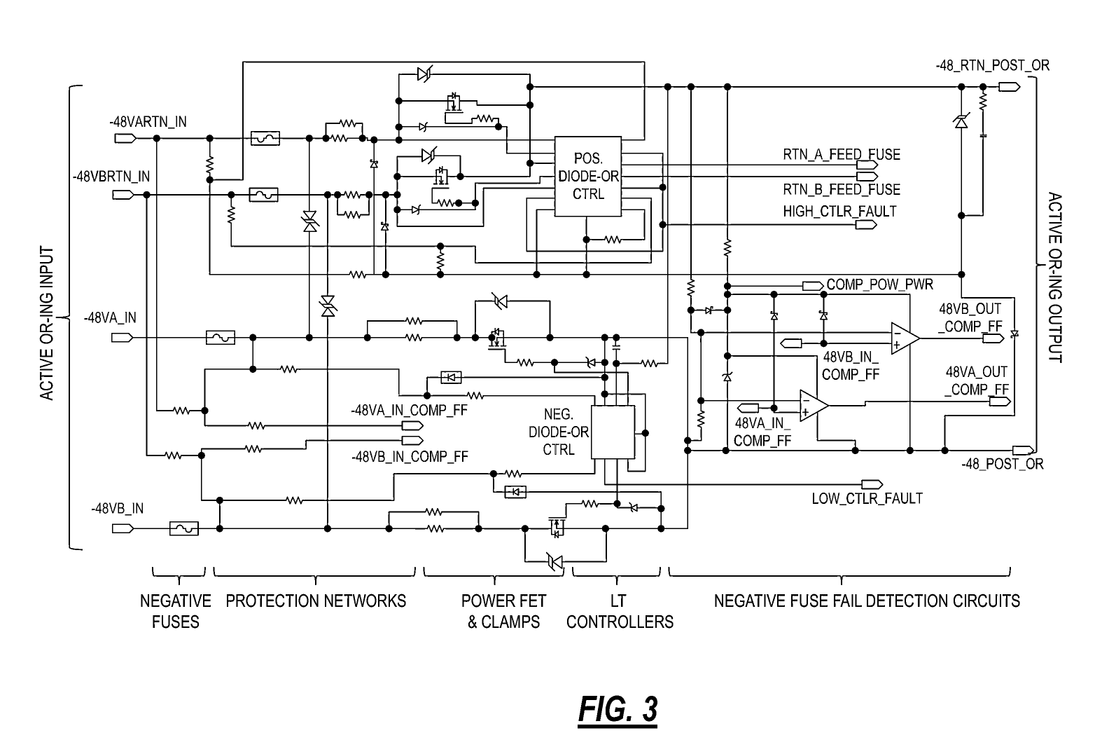

The return relay isolation and fuse circuit 28 connects to a fuse and sensor circuit 34 which connects to a bi-polar transient voltage suppressor (TVS) Zener diode circuit 36 which connects to an active FET Or-ing circuit 38. Each of the circuits 34, 36, 38 is a high voltage circuit with high current therebetween. FIG. 3 illustrates an exemplary circuit implementation of the circuits 34, 36, 38, namely FIG. 3 is a circuit schematic for a dual feed high and low active FET Or-ing circuit. FIG. 3 shows connections to the active Or-ing circuit inputs and outputs including controller alarm as well as fuse-fail detection circuits. Using the circuit features shown in FIG. 3, the circuit 10 for the A and B feed −48V power and return connections for modules that present a total load in excess of 500 W for either feed present or with both feeds together.

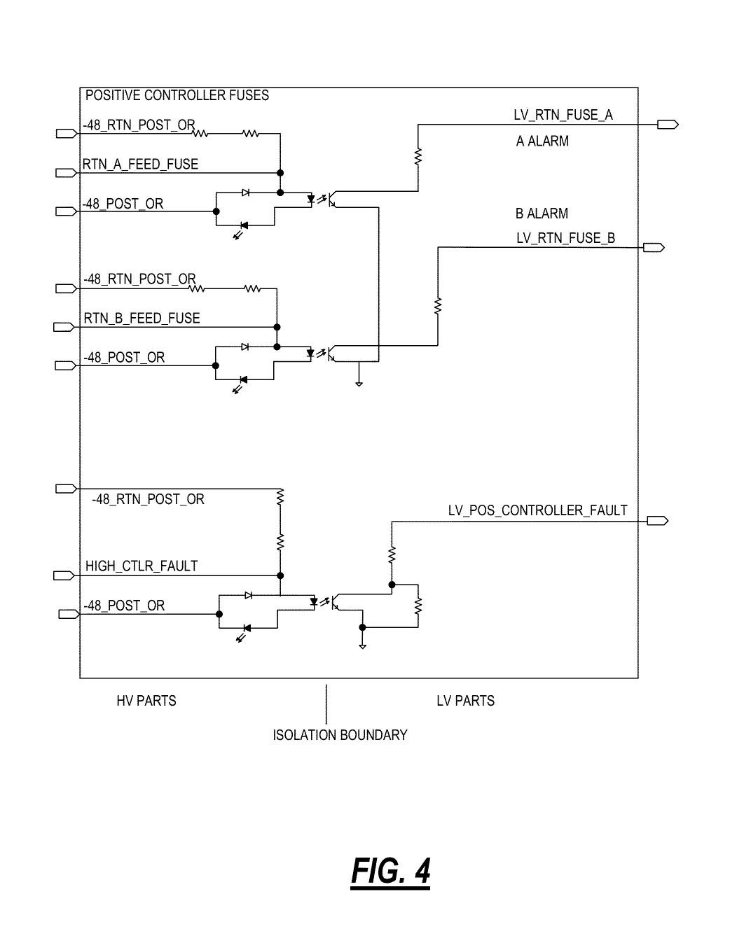

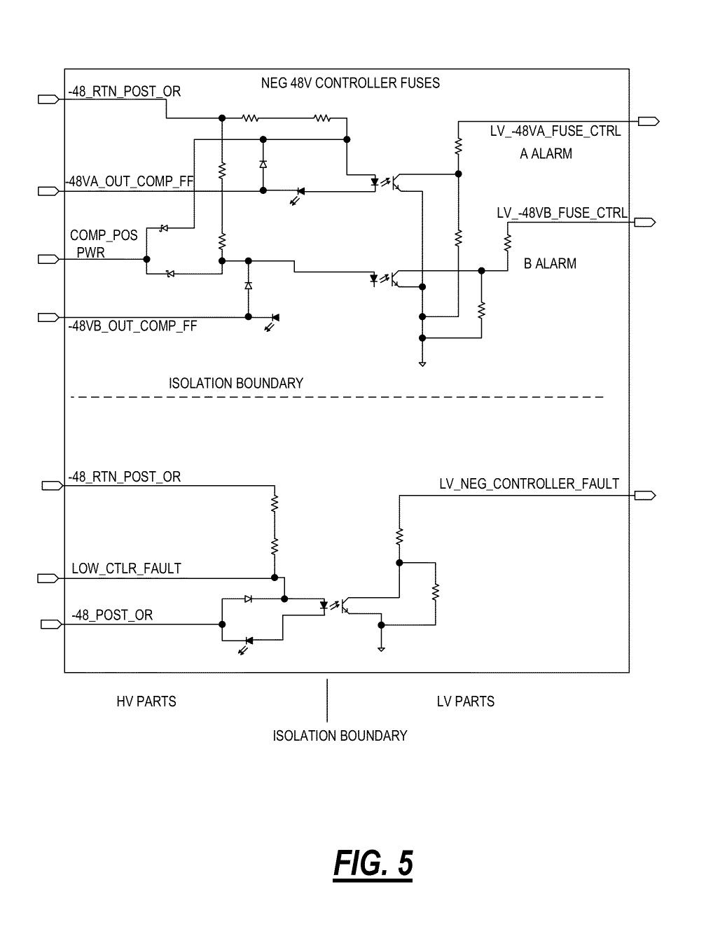

The bi-polar fuse and sensor circuit 34 connects via low current to an alarm isolation and circuit status circuit 40 which is both a high and low voltage circuit. The alarm isolation and circuit status circuit 40 connects at low voltage to an active Or-ing circuit and fuse status output driver/LED circuit 42. The circuits 40, 42 are illustrated in an exemplary circuit implementation of FIGS. 4-5. Specifically, FIGS. 4-5 are schematics of optoisolators and LED circuits for active Or-ing FET, controllers, and fuse status indication. FIG. 4 is the positive controller fuses and FIG. 5 is the negative controller fuses. Note, the circuits 40, 42 are both high and low voltage with an isolation boundary between high voltage (HV) parts and low voltage (LV) parts. FIG. 4 is a positive control fault detection circuit with the LED being green, for example, unless there is an excessive FET drop or an input supply failure. FIG. 5 is a negative control fault detection circuit that has the LED normally off but the LED can be on, e.g. red, if the FET has failed in either a shorted or open mode.

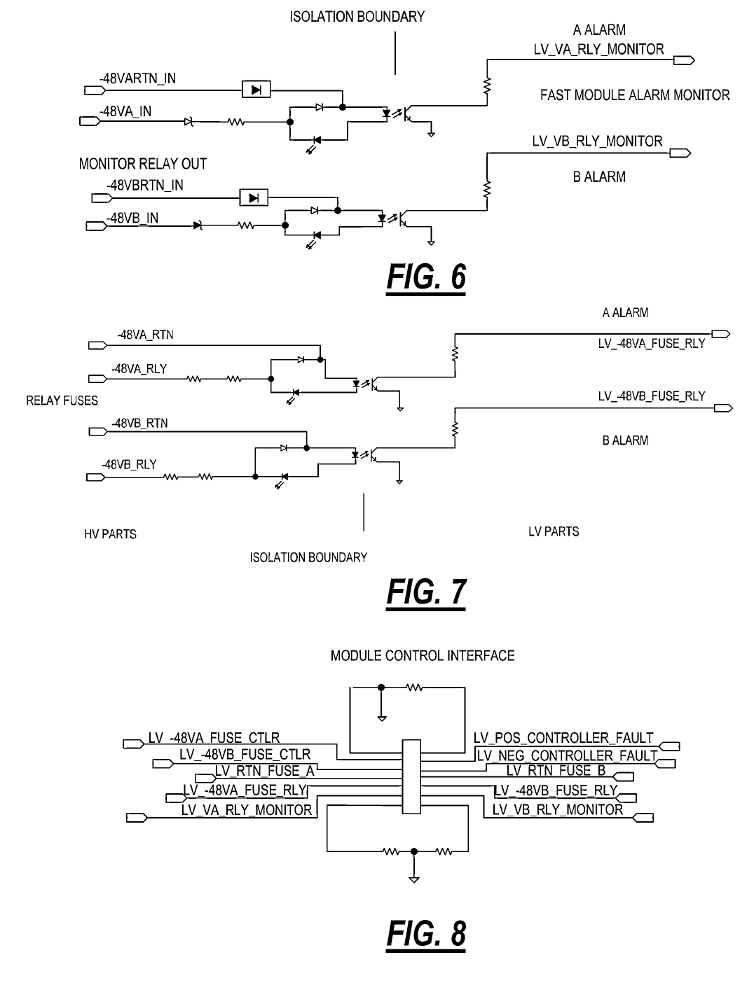

The active Or-ing circuit and fuse status output driver/LED circuit 42 connects to an alarm control circuit 44. The power input distribution circuit 26 and the return relay isolation and fuse circuit 28 connect via low current to a feed/relay monitor/fuse alarm isolation and circuit status circuit 46. The feed/relay monitor/fuse alarm isolation and circuit status circuit 46 connects to a feed status output drivers, LED, and revision identification circuit 48 which connects to the alarm control circuit 44. The alarm control circuit 44 can connect to a module control circuit 50 external to the circuit 10 such as on the module in which the circuit 10 is included. FIGS. 6-8 include exemplary circuit implementations of the circuits 44, 46, 48. Specifically, FIG. 6 is a monitor relay out circuit, FIG. 7 is a relay fuses circuit, and FIG. 8 is a module control interface circuit. In FIGS. 6-8, the high voltage components form the high voltage part of the circuit 46 and the low voltage components form the low voltage circuits 44, 48.

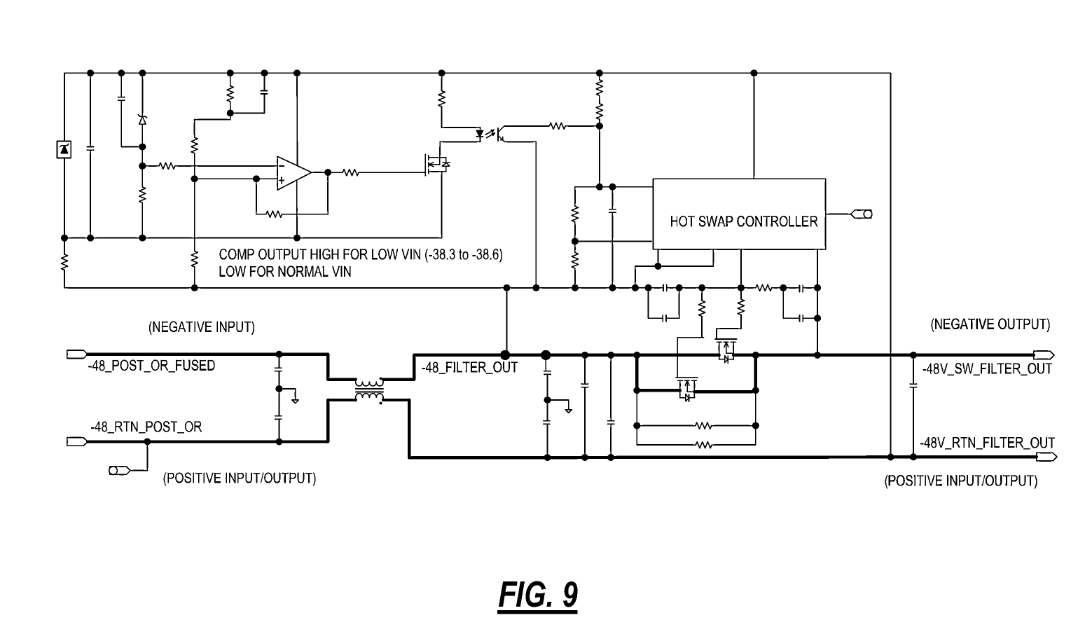

The output fuse and LED circuit 32 connects to a differential mode (DM) electromagnetic interference (EMI) filter circuit 52 which connects to an output common mode (CM) EMI filter circuit 54 which connects to an output filter capacitor circuit 56. FIG. 9 illustrates an exemplary circuit implementation of the circuits 52, 54, 56 each of which is a high voltage circuit. Further, high current is illustrated in FIG. 9 with bold lines. FIG. 9 is a hot swappable CM/DM power line filter, overvoltage cutoff, and low voltage battery disconnect (LVD) and recovery circuit.

In the event of an active Or-ing circuit failure (such as a shorted MOSFET, controller or other active Or-ing component), the power feed entry circuit 10 provides a visual LED indication as well as isolated alarm signals to its associated module while still delivering power to the module through the parallel Or-ing diodes. The alarms and status LED can be displayed on the front of the module with various green/red LEDs for positive controller, negative controller, A & B return, A & B relays, and A & B monitoring. Thus, the power feed entry circuit 10 eliminates the potential for silent failure as noted with failed diodes present in conventional high power modules. This prevents optical data interruption as well as Electromagnetic Compatibility (EMC) and safety compliance failures. The power feed entry circuit 10 includes features for Reverse Power Connection Protection.

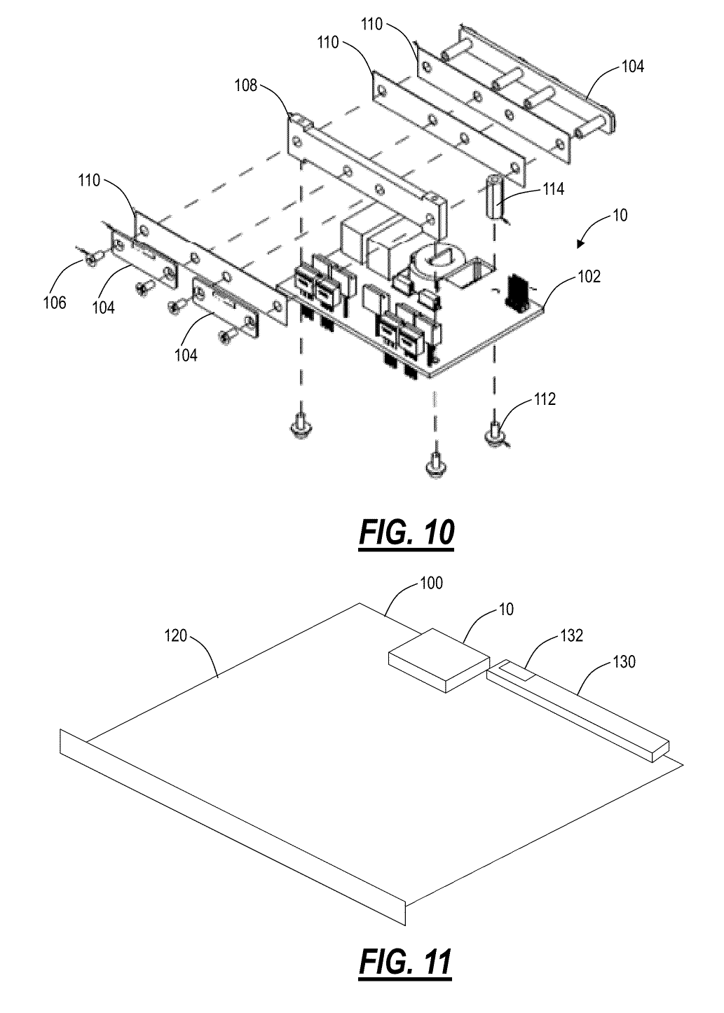

Referring to FIGS. 10-11, in an exemplary embodiment, perspective views illustrates an exemplary implementation of the power feed entry circuit 10 as a daughterboard or plug in module to another module 100. Specifically, FIG. 10 is a perspective view of the power feed entry circuit 10, and FIG. 11 is a perspective view of the power feed entry circuit 10 on the module 100. The components used in the power feed entry circuit 10 take up less than 3 square inches of PCB space and are less than 1 inch tall including the heat sink. In FIG. 10, the circuit 10 includes a PCB 102 with the various circuits and components described in FIGS. 1-9 contained thereon. The circuit 10 includes various hardware for mounting to the module 100 as well as heat sinks The hardware can include retainer plates 104 with retainer screws 106 received therethrough, mounting and heat sink material 108, and thermal interface material 110. Mounting screws 112 mount the circuit 10 to the module 100 via the material 108 and mounting standoffs 114. As described herein, the module 100 can be a high-powered telecom or datacom device. It may also be any computing device. The module 100 also includes a PCB 120 on which the circuit 10 is mounted. The module 100 can include backplane connectors 130 which can include power connectors 132. The circuit 10 is configured to connect to the power connectors 132 via the PCB 120 and to provide isolated DC/DC power to other components (not shown) on the module 100.

The unique advancements achieved and problems resolved by the power feed entry circuit 10 include the following:

1. Present state-of-the-art diode Or-ing circuits dissipate in excess of 12 W when supporting loads up to 500 W while the active Or-ing circuit components in the power feed entry circuit 10 dissipate less than 2 watts. The active Or-ing circuits described herein incorporate features that provide dual feed interface circuits that support loads greater than 500 W with either one or both of the feeds present and result in a greater than 85% reduction in Or-ing function power loss as compared to conventional approaches. The Or-ing function power loss alone may correspond to an approximate 400 W reduction in worst case application diode power for a typical telecom system comprised of multiple modules as described. The collocated component power loss reduction, as well as the fan speed reduction associated with the disclosed circuit usage further contribute to the reduction in the total power loss.

2. Present state-of-the-art diode Or-ing circuits do not have the capability to detect failed components while the active Or-ing circuit described in the power feed entry circuit 10 detects failed components and issues alarms. The circuit 10 monitors the performance and operational health of all four Or-ing MOSFETs by monitoring the voltage drops across the MOSFET drain-to-source nets and comparing these to programmed controller alarm voltage thresholds. The various other circuit characteristics of most critical circuit components including controllers, alarm interface devices, and transient protectors are also monitored and ported to the alarm circuits. If a failure occurs with the active Or-ing circuit, a system alarm is issued. If the failure results in the interruption of a MOSFET power path, the circuit 10 includes a failsafe alternate power path using power diodes connected in parallel across each MOSFET. Thus, the design approach of the circuit 10 overcomes several of the greatest limitations of present state-of-the-art circuits by issuing comprehensive alarms in the event of a failure while reliably maintaining the load power path under fault conditions. This unique combination of features provided by this hybrid protection scheme is not found in other state-of-the-art Or-ing circuits.

3. Present state-of-the-art diode Or-ing circuits result in ambient temperature rise and PCB temperature rises in excess of 60 C when supporting loads of 500 W. This excessive temperature rise causes other components on the same PCB to experience a temperature rise as well and requires system fans to run faster for cooling. These problems further increase the system power loss as well as reduced the system reliability due to shorter fan life and component aging. The active Or-ing circuit components in the power feed entry circuit have a much lower temperature rise that is less than 20 C under a 500 W load condition. Also, the temperature rise of the disclosed active Or-ing transistors as well as the controllers is not significant with loads above 500 W even under single feed conditions when compared to diode Or-ing.

4. Present active MOSFET Or-ing circuits do not contain circuitry to prevent return path current flow when the corresponding feed is removed while the power feed entry circuit 10 provides this capability. The circuit 10 contains additional features for power feed return isolation and current flow balancing. These features assure that no current flow may occur on the power return path when the corresponding feed source is not present. The lack of this circuit that isolates return current flow when one feed is removed may present safety requirement compliance concerns (see ATT-TP-76200), including current overload in source-to-source potential-equalizing wiring, which may not be adequately rated to support the source-to-load current level. The circuit 10 incorporates an active power feed return current balance feature to isolate the return current when a feed is removed. This feature includes transient protection to assure reliable operation in all application environments.

5. Present state-of-the-art active Or-ing circuits can only support loads of less than 300 W while the power feed entry circuit 10 can support over 500 W loads. The present state-of-the-art active Or-ing circuits using MOSFETs have output load current capability that is limited to approximately 5 Amps, corresponding to significantly less than 300 W deliverable power per module. This 300 W limit is far less than that required for many applications. The circuit 10 has proven to be effective and reliable when powering loads in excess of 500 W under all intended application operating conditions. This is achieved though the unique use of low RDS(on) MOSFETs in combination with ballast resistive networks and fuses in combination with the connections to the active Or-ing controller control and alarm circuits.

6. Present state-of-the-art active Or-ing circuits lack adequate transient and fault immunity to prevent component damage when subjected to line side surge and/or transient conditions as well as line or load side faults per regulatory telecomm compliance standards. The power feed entry circuit 10 is very robust and has been subjected to faults as required for Network Equipment-Building System (NEBS) GR1089 compliance as well as all required line surge, transient or EFT tests at levels including in excess of 500V without any component damage. The circuit 10 contains line and load electrical filter circuits using custom magnetic parts to limit both differential and common mode conducted emission levels that could be present. The circuit 10 also has transient and fault protection devices to prevent all component hard failures that may occur when the circuit is subjected to events required for compliance with potential carrier application requirements. In addition, the circuit 10 includes features to process all associated alarm features and provide visual, as well as software driven, indications of any problems.

7. Present state-of-the-art active Or-ing circuits lack the ability to provide power to the load in the event of a component failure while the circuit 10 has a hybrid parallel diode architecture that provides the capability of supplying power under power path component fault conditions. The power feed entry circuit 10 includes the negative fuse fail detection capability that provides fuse fail detection of the fuses needed to isolate the MOSFET circuit from the corresponding parallel diode circuit. Many telecom providers, carriers, etc. require that all fuse failures be detected and reported though system alarms. The direct measurement of a failure of either negative feed fuse at the controller input is not detectable using any available negative controllers due to problems introduced by feedback within the negative controller devices. One potential approach to this problem is to not use fuses at the negative controller MOSFET inputs, but to locate the fuses on the line side of the MOSFET feed nets, but in that case a feed fuse failure (such as one caused by a shorted MOSFET or controller chip) would cause the parallel diode to also be removed from the circuit and therefore would eliminate the advantages of the hybrid protection scheme provided by the parallel diodes. An alternative approach is the use of GMT fuses to detect negative controller feed fuse failures, but this approach requires an excessive PCB board area and relatively expensive components. Thus, the negative fuse fail detection circuit in the circuit 10 uses unique rail-to-rail comparator circuits in combination with protection circuits that interface through the negative controller to detect the opening of either of the miniature feed protection fuses.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. A power feed entry circuit, comprising:
inputs coupled to redundant power feeds;
outputs coupled to components on a module;
a first circuit coupled to the inputs and the outputs, wherein the first circuit is configured for power connections, return isolation relays, diode Or-ing, and output fuse light emitting diodes (LEDs);
a second circuit coupled to the first circuit, the inputs, and the outputs, wherein the second circuit is configured with a hot swappable controller and for common-mode and differential mode power line filtering;
a third circuit coupled to the first circuit, wherein the third circuit is configured for alarm monitoring of the first circuit and the second circuit; and
a fourth circuit coupled to the first circuit and the third circuit, wherein the fourth circuit comprises a dual feed high and low active field effect transistor Or-ing circuit;
wherein the first circuit, the second circuit, and the fourth comprise high voltage and high current circuits, and wherein the third circuit comprises a high and low voltage and low current circuit.

2. The power feed entry circuit of claim 1, wherein the power feed entry circuit is configured for loads in excess of 500 W with a corresponding power dissipation by the first circuit, the second circuit, and the third circuit of less than 2 W.

3. The power feed entry circuit of claim 1, wherein the fourth circuit comprises a plurality of Or-ing metal-oxide-semiconductor field-effect transistors (MOSFETs), and wherein the third circuit is configured to monitor voltage drops across the MOSFETs drain-to-source nets for comparison to programmed controller alarm voltage thresholds and for raising alarms based thereon.

4. The power feed entry circuit of claim 3, wherein the third circuit is configured to monitor a plurality of components in the first circuit, the second circuit, and the fourth circuit for operational status and for raising alarms based thereon.

5. The power feed entry circuit of claim 3, wherein the fourth circuit comprises a failsafe alternate power path using power diodes connected in parallel across each MOSFET.

6. The power feed entry circuit of claim 5, wherein the power diodes are arranged in a hybrid parallel diode architecture that provides the capability of supplying power under power path component fault conditions.

7. The power feed entry circuit of claim 1, wherein the first circuit comprises an active power feed return current balance to isolate the return current when a feed is removed.

8. A module for use in high powered telecom applications, comprising:
a board comprising a plurality of connectors to a backplane; and
a power feed entry circuit coupled to some of the plurality of connectors for receiving power feeds and coupled to at least one component on the board for providing isolated power thereto;
wherein the power feed entry circuit comprises:
inputs coupled to the some of the plurality of connectors;
outputs coupled to the at least one component;
a first circuit coupled to the inputs and the outputs, wherein the first circuit is configured for power connections, return isolation relays, diode Or-ing, and output fuse light-emitting diodes (LEDs);
a second circuit coupled to the first circuit, the inputs, and the outputs, wherein the second circuit is configured with a hot-swappable controller and for common-mode and differential mode power line filtering;
a third circuit coupled to the first circuit, wherein the third circuit is configured for alarm monitoring of the first circuit and the second circuit; and
a fourth circuit coupled to the first circuit and the third circuit, wherein the fourth circuit comprises a dual feed high and low active field effect transistor Or-ing circuit;
wherein the first circuit, the second circuit, and the fourth comprise high voltage and high current circuits, and wherein the third circuit comprises a high and low voltage and low current circuit.

9. The module of claim 8, wherein the power feed entry circuit is configured for loads in excess of 500 W with a corresponding power dissipation by the first circuit, the second circuit, and the third circuit of less than 2 W.

10. The module of claim 8, wherein the fourth circuit comprises a plurality of Or-ing metal-oxide-semiconductor field-effect transistors (MOSFETs), and wherein the third circuit is configured to monitor voltage drops across the MOSFETs drain-to-source nets for comparison to programmed controller alarm voltage thresholds and for raising alarms based thereon.

11. The module of claim 10, wherein the third circuit is configured to monitor a plurality of components in the first circuit, the second circuit, and the fourth circuit for operational status and for raising alarms based thereon.

12. The module of claim 10, wherein the fourth circuit comprises a failsafe alternate power path using power diodes connected in parallel across each MOSFET.

13. The module of claim 12, wherein the power diodes are arranged in a hybrid parallel diode architecture that provides the capability of supplying power under power path component fault conditions.

14. The module of claim 8, wherein the first circuit comprises an active power feed return current balance to isolate the return current when a feed is removed.

15. A daughter board for use in a high powered telecom module, comprising:
a printed circuit board comprising a power feed entry circuit, wherein the printed circuit board is mounted on the high powered telecom module;
wherein the power feed entry circuit comprises:
inputs coupled to a power feed via the module;
outputs coupled to at least one component on the module;
a first circuit coupled to the inputs and the outputs, wherein the first circuit is configured for power connections, return isolation relays, diode Or-ing, and output fuse light emitting diodes (LEDs);
a second circuit coupled to the first circuit, the inputs, and the outputs, wherein the second circuit is configured with a hot-swappable controller and for common-mode and differential mode power line filtering;
a third circuit coupled to the first circuit, wherein the third circuit is configured for alarm monitoring of the first circuit and the second circuit; and
a fourth circuit coupled to the first circuit and the third circuit, wherein the fourth circuit comprises a dual feed high and low active field-effect transistor Or-ing circuit;
wherein the first circuit, the second circuit, and the fourth comprise high voltage and high current circuits, and wherein the third circuit comprises a high and low voltage and low current circuit.

16. The daughter board of claim 15, wherein the power feed entry circuit is configured for loads in excess of 500 W with a corresponding power dissipation by the first circuit, the second circuit, and the third circuit of less than 2 W.

17. The daughter board of claim 15, wherein the fourth circuit comprises a plurality of Or-ing metal-oxide-semiconductor field-effect transistors (MOSFETs), and wherein the third circuit is configured to monitor voltage drops across the MOSFETs source-to-drain nets for comparison to programmed controller alarm voltage thresholds and for raising alarms based thereon.

18. The daughter board of claim 17, wherein the third circuit is configured to monitor a plurality of components in the first circuit, the second circuit, and the fourth circuit for operational status and for raising alarms based thereon.

19. The daughter board of claim 15, wherein the fourth circuit comprises a failsafe alternate power path using power diodes connected in parallel across each MOSFET; and
wherein the first circuit comprises an active power feed return current balance to isolate the return current when a feed is removed

20. The daughter board of claim 19, wherein the power diodes are arranged in a hybrid parallel diode architecture that provides the capability of supplying power under power path component fault conditions.
